(19) United States
(12) Patent Application Publication
(10) Pub. No.: US 2023/0196185 A1
(43) Pub. Date: Jun. 22, 2023

(54) GENERATING AND MAINTAINING A FEATURE FAMILY REPOSITORY OF MACHINE LEARNING FEATURES

(71) Applicant: Chime Financial, Inc., San Francisco, CA (US)

(72) Inventors: Akshay Jain, Boise, ID (US); Peeyush Agarwal, Mountain View, CA (US); Frank Teoh, Milpitas, CA (US)

(21) Appl. No.: 17/558,375

(22) Filed: Dec. 21, 2021

(51) Int. Cl. G06N 20/00; G06K 9/62

(52) U.S. Cl. CPC G06N 20/00; G06K 9/6227; G06K 9/6215; G06K 9/6261; G06K 9/6228

(57) ABSTRACT

This disclosure describes a feature family system that, as part of an inter-network facilitation system, can intelligently generate and maintain a feature family repository for quickly and efficiently retrieving and providing machine learning features upon request. For example, the disclosed systems can generate a feature family repository as a centralized network location of feature references indicating network locations where different machine learning features are stored. In some cases, the disclosed systems identify a stored feature family that matches the request and retrieves the stored features from their respective network locations. The disclosed systems can generate feature families for online features as well as offline features and can automatically update feature values associated with various machine learning features on a period basis or in response to trigger events.

### BACKGROUND

Recent machine learning developments have led to an increased demand for machine learning models in widespread applications. For example, the proliferation of machine learning models has resulted in their integration in systems such as online banking systems. Indeed, conventional machine learning systems have developed that can train and utilize machine learning models to, for instance, detect fraudulent activity within an online banking system. Despite these recent advances, however, conventional machine learning systems continue to exhibit a number of drawbacks or deficiencies.

For example, some conventional machine learning systems are slow and inefficient. In particular, conventional systems often utilize models that call for machine learning features generated from account activity or other components of an interconnected online banking network. Unfortunately, generating requested machine learning features across various network components often has high latency which results in slow response times (e.g., on the order of hours or days in some cases) for many conventional systems. Furthermore, some conventional systems have little to no consistency or governance regarding storage and dissemination of previously generated machine learning features, instead requiring re-generation of features from raw data for each new request or application. This inconsistency and lack of governance often results in generating redundant features many times over for different requests, thereby wasting computational resources such as processing power and memory and leading to further slowdowns.

Due at least in part to their inefficient nature, some conventional machine learning systems are also insecure. More specifically, in the case of applying a machine learning model to authenticate an action associated with an online bank account, the high latency of many existing systems in generating features can lead to imprecise and inaccurate data and data features used as input for the machine learning model. In most cases, fraudsters move money from an online account within minutes of gaining access. Accordingly, because of their slow response time in generating features from this (or other) abnormal data, and/or because data and data features used for a given machine learning model may be inaccurate, existing systems cannot adequately prevent fraudsters from taking unauthorized actions before machine learning models can recognize the fraudulent activity.

Additionally, certain conventional machine learning systems are inflexible. To elaborate, many conventional systems rigidly require generating machine learning features for each new task, request, or model application. For example, when an existing system receives a request for particular data features, the system generates the features based on data available to the system at the time, and the system does so for each new request. Consequently, the existing system cannot adapt to provide feature values for machine learning features at different points in time. As a further consequence of requiring re-generation of features for each request, such existing systems cannot flexibly associate or correlate machine learning features for different requests (e.g., requests for features to apply to different types of machine learning models and/or for different tasks and/or at different times).

These, along with additional problems and issues, exist with conventional machine learning systems.

### SUMMARY

This disclosure describes one or more embodiments of methods, non-transitory computer-readable media, and systems that can solve the foregoing problems in addition to providing other benefits by generating and maintaining a feature family repository for quickly and efficiently retrieving and providing machine learning features upon request. For example, the disclosed systems can generate a feature family repository as a centralized network location of feature references indicating network locations where different machine learning features are stored. In some cases, rather than generating new features for a given request, the disclosed systems identify a stored feature family that matches the request (e.g., a stored feature family that includes references to requested features) and can retrieve the stored features from their respective network locations. The disclosed systems can generate feature families for online features as well as offline features and can automatically update feature values associated with various machine learning features on a period basis or in response to trigger events.

### BRIEF DESCRIPTION OF THE DRAWINGS

The detailed description refers to the drawings briefly described below.

FIG. 1 illustrates a block diagram of an environment for implementing an inter-network facilitation system and a feature family system in accordance with one or more embodiments.

FIG. 2 illustrates an example overview of generating and providing a feature family in accordance with one or more embodiments.

FIG. 3A illustrates an example process for generating a feature family in accordance with one or more embodiments.

FIG. 3B illustrates an example process for using outputs of a machine learning model as features in a feature family in accordance with one or more embodiments.

FIG. 4 illustrates an example diagram for retrieving machine learning features for a feature family to generate a machine learning prediction based on a request in accordance with one or more embodiments.

FIG. 5 illustrates an example feature family in accordance with one or more embodiments.

FIG. 6 illustrates an example diagram for retrieving a historical version of a feature family at a point in time in accordance with one or more embodiments.

FIG. 7 illustrates an example diagram for intelligently generating or modifying a feature family in accordance with one or more embodiments.

FIG. 8 illustrates an example series of acts for generating, retrieving, and providing feature families in accordance with one or more embodiments.

FIG. 9 illustrates a block diagram of a computing device for implementing one or more embodiments of the present disclosure.

FIG. 10 illustrates an example environment for an inter-network facilitation system in accordance with one or more embodiments.

### DETAILED DESCRIPTION

This disclosure describes a feature family system that can generate and maintain a feature family repository for quickly and efficiently retrieving and providing machine learning features upon request. To elaborate, the feature family system can generate, store, and retrieve feature families within a feature family repository. In practical scenarios, machine learning models often require different sets or families of machine learning features to train or apply learned parameters for one task or another. In the case of login authentication, for instance, machine learning models require machine learning features pertaining to a particular client device and/or a particular user account to determine whether the login attempt is valid or fraudulent. In these login authentication scenarios, speed is essential to prevent account takeovers where, for example, fraudsters attempt to transfer funds from online banking accounts and only timely action would prevent the fraudulent activity. To facilitate fast, efficient, flexible generation and retrieval of machine learning features, the feature family system generates a repository of feature families stored at an easily accessible centralized server location, where the feature families include feature references indicating network locations where various machine learning features are generated and/or stored (or where the feature families include the machine learning features themselves).

As just mentioned, the feature family system can generate feature families for machine learning features. In particular, the feature family system can receive an indication from a client device (e.g., a data scientist device) to generate one or more machine learning features and/or to group the one or more machine learning features in a feature family. The feature family system can generate a feature family that includes the requested machine learning features, or that includes feature references pointing to (or otherwise indicating) network locations where the features are generated or stored (e.g., a client-device-specific network component that generates and stores machine learning features related to device activity in an app and/or an engineering-data-specific network component that generates and stores machine learning features related to engineered data relating to the feature family system and/or user accounts). In some cases, the feature family system generates the requested machine learning features by determining feature values from raw data and/or from engineered data. In some embodiments, the feature family system thus generates feature families that are explorable and reusable across machine learning models, applications, and use cases.

In certain embodiments, the feature family system receives a request for a feature family. For example, the feature family system receives a request from a client device (e.g., a machine learning engineer device) to utilize or implement a feature family with a machine learning model associated with an action within the online banking system. For example, the feature family system receives a request to apply a login authentication machine learning model to a feature family stored within a feature family repository. In response, the feature family system can identify the requested feature family and can retrieve the machine learning features from their respective network locations as indicated by the feature references in the feature family. The feature family system can also provide the machine learning features of the feature family to the client device for implementation by, or training of, a machine learning model. For instance, the feature family system provides machine learning features to a login authentication machine learning model in a very quick turnaround (e.g., milliseconds) after receiving the response to facilitate a speedy prediction of a fraudulent account takeover.

As suggested above, the disclosed feature family system provides several improvements or advantages over conventional machine learning systems. For instance, the feature family system can improve speed and efficiency over conventional machine learning systems. To elaborate, for each new request, existing systems suffer from high latency and slow response times as a result of requiring communication across multiple network components (e.g., different servers or other interconnected network actors) to generate new machine learning features associated with the different components. The feature family system, by contrast, can reduce latency and response times for requests by storing feature families (e.g., from previously generated or requested machine learning features) within a feature family repository for quick, efficient access of machine learning features across an inter-network facilitation system (e.g., reducing from hours in previous systems down to milliseconds).

By generating and storing feature families in a feature family repository, the feature family system can further improve efficiency and preserve computing resources expended by conventional systems. Indeed, whereas prior systems often generate redundant features due to inconsistency and lack of governance in machine learning feature management, the feature family system can avoid redundant re-generation of machine learning features by storing and maintaining machine learning features in a centralized network location. Embodiments of the feature family system provide improved governance and consistency of machine learning features across the various network locations (e.g., servers and other network actors) of an inter-network facilitation system. Consequently, the feature family system can save computing resources such as processing power and memory by storing and maintaining previously generated machine learning features in an easily accessible, intelligent manner instead of re-generating features each time they are called.

As a result of improving speed and efficiency, embodiments of the feature family system can also improve data security over conventional machine learning systems. More specifically, because the feature family system generates feature families that include references to network locations of stored machine learning features, the feature family system can retrieve and provide the machine learning features much more quickly than prior systems. Thus, the feature family system is less exploitable and more secure than many existing systems because the feature family system can facilitate much faster authentication predictions via machine learning models based on near real-time data such as changes to profile information, multiple reaches to member services, and/or failed login attempts from different IP address and devices. Compared to some conventional systems that may take hours or days to provide new features for application via a machine learning model (which is far too slow to prevent most account takeovers), the feature family system can retrieve and provide machine learning features within milliseconds using the feature family repository described herein (and can therefore catch many more account takeover attempts missed by previous systems).

In addition, embodiments of the feature family system can improve flexibility over conventional machine learning systems. In particular, while many conventional systems generate new features for each new request (and therefore do not store different versions of machine learning features as they change over time), the feature family system is able to flexibly access or determine feature values of machine learning features at various points in time. For example, the feature family system can store versions of a feature family or a machine learning feature within a feature family repository. Thus, upon receiving a prediction query requesting features and/or feature values associated with a previous prediction (e.g., made via a machine learning model), the feature family system can access and provide (features values for) a version of the feature family used to generate the previous prediction. Indeed, unlike prior systems that require re-generation of features for each request, the feature family system can flexibly and associate or correlate feature families for different requests (e.g., reusable to apply different machine learning models for different tasks).

As indicated by the foregoing discussion, the present disclosure utilizes a variety of terms to describe features and advantages of the feature family system. For example, as used herein, the term “machine learning feature” (or sometimes simply “feature”) refers to digital information or data describing actions performed by or within a computer system (e.g., an inter-network facilitation system). For instance, machine learning features can include data relating to online banking accounts, device activity, network activity, and/or one or more user accounts registered within an inter-network facilitation system. In some cases, features are represented as vectors, tensors, or codes (e.g., latent codes) that are extracted utilizing a machine learning model. In some embodiments, features are engineered as combinations of raw data received from client devices or other connected components of a network.

Features can include observable characteristics or observable information pertaining to an inter-network facilitation system such as numbers of login attempts, account balances, usernames, and IP addresses. In other cases, features include latent features (e.g., features within the various layers of a machine learning model and that may change as they are passed from layer to layer) and/or unobservable deep features generated by a machine learning model. In some embodiments, a machine learning feature includes (or is associated with) a feature name (e.g., an arrangement of characters referencing the feature) and a feature value (e.g., a data point determined via raw data) that indicates the information or data within the feature.

In some cases, machine learning features can include online features or offline features. An “online feature” generally refers to a machine learning feature generated from data that is actively changing or updating. For example, an online feature can include a feature that is determined or updated contemporaneously or concurrently with network activity (e.g., changes to client device activity, account balances, etc.). Conversely, an “offline feature” refers to a machine learning feature that is generated from a static dataset or that is determined or updated on a periodic basis. For example, an offline feature can include a machine learning feature that is not generated from network activity but from other data such as sender identifications, recipient identifications, and other information that is less active.

Along these lines, the term “feature family” refers to a collection or group of machine learning features or feature references indicating locations of machine learning features. For example, a feature family can include a feature reference indicating a network location where a corresponding feature is generated and/or stored. A feature family can include multiple feature references indicating machine learning features stored at different network locations (e.g., interconnected across various geographic locations) within an inter-network facilitation system. In some cases, a feature family can include online features, offline features, or a combination of online and offline features. A feature family can include certain information designating the feature family, such as a feature family name, an entity name (e.g., a name of a particular entity or entity type within the inter-network facilitation system to which the features of feature family apply), and feature names of machine learning features included in (or referenced by) the feature family.

In some cases, a “feature reference” refers to an indicator or a pointer specifying a network location where a machine learning feature is generated and/or stored. For instance, a feature reference indicates a particular network storage location, server, device, or other network component that gathers raw data for feature values, generates features from the feature values, and/or stores the feature values for the features.

As used herein, the term “machine learning model” refers to a computer algorithm or a collection of computer algorithms that automatically improve for a particular task through experience based on use of data. For example, a machine learning model can utilize one or more learning techniques to improve in accuracy and/or effectiveness. Example machine learning models include various types of decision trees, support vector machines, Bayesian networks, linear regressions, logistic regressions, random forest models, or neural networks (e.g., deep neural networks).

Relatedly, the term “neural network” refers to a machine learning model that can be trained and/or tuned based on inputs to determine classifications or approximate unknown functions. In particular, the term neural network can include a model of interconnected artificial neurons (e.g., organized in layers) that communicate and learn to approximate complex functions and generate outputs (e.g., determinations of digital image classes) based on a plurality of inputs provided to the neural network. In addition, a neural network can refer to an algorithm (or set of algorithms) that implements deep learning techniques to model high-level abstractions in data.

As mentioned above, the feature family system operates within, or as part of, an inter-network facilitation system. As used herein, the term “inter-network facilitation system” refers to a system that includes the feature family system and that facilitates digital communications across different computing systems over one or more networks. For example, an inter-network facilitation system manages financial information, such as credit accounts, secured accounts, and other accounts for a single account registered within the inter-network facilitation system. In some cases, the inter-network facilitation system is a centralized network system that facilitates access to online banking accounts, credit accounts, and other accounts via a central network location. Indeed, the inter-network facilitation system can link accounts from different network-based financial institutions to provide information regarding, and management tools for, the different accounts.

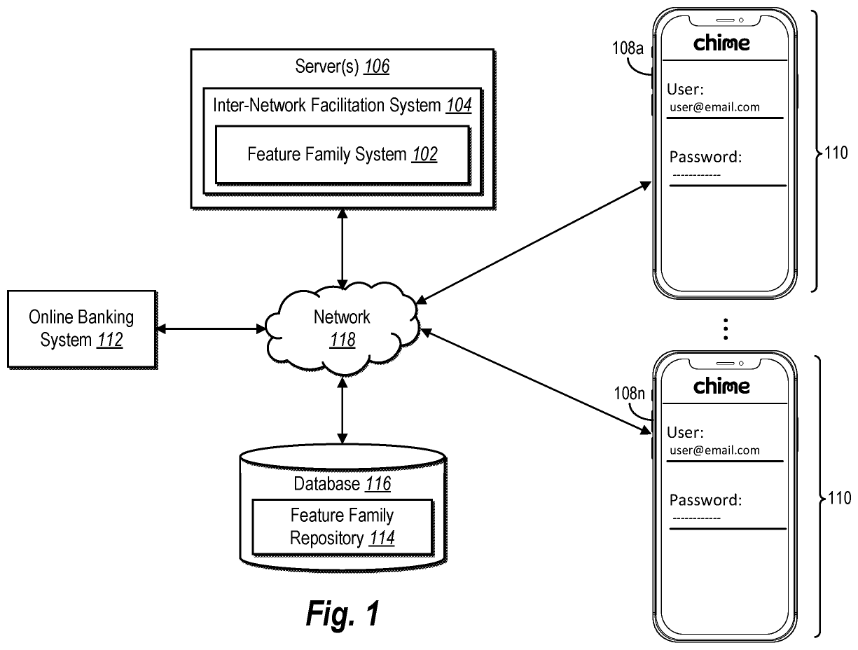

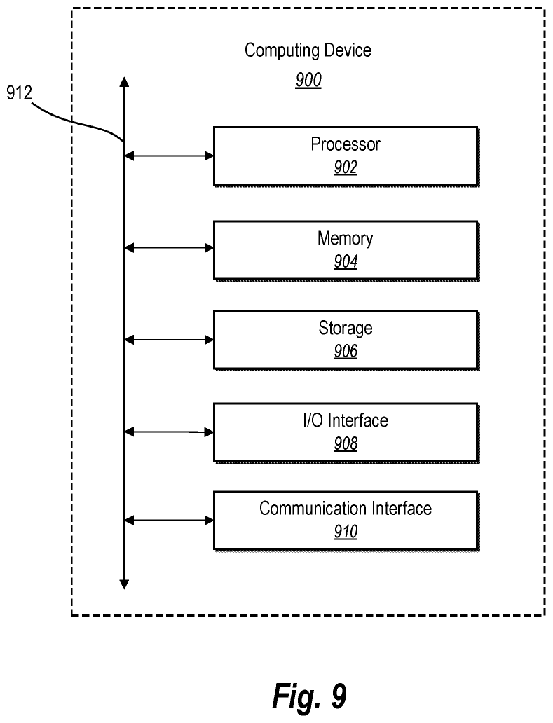

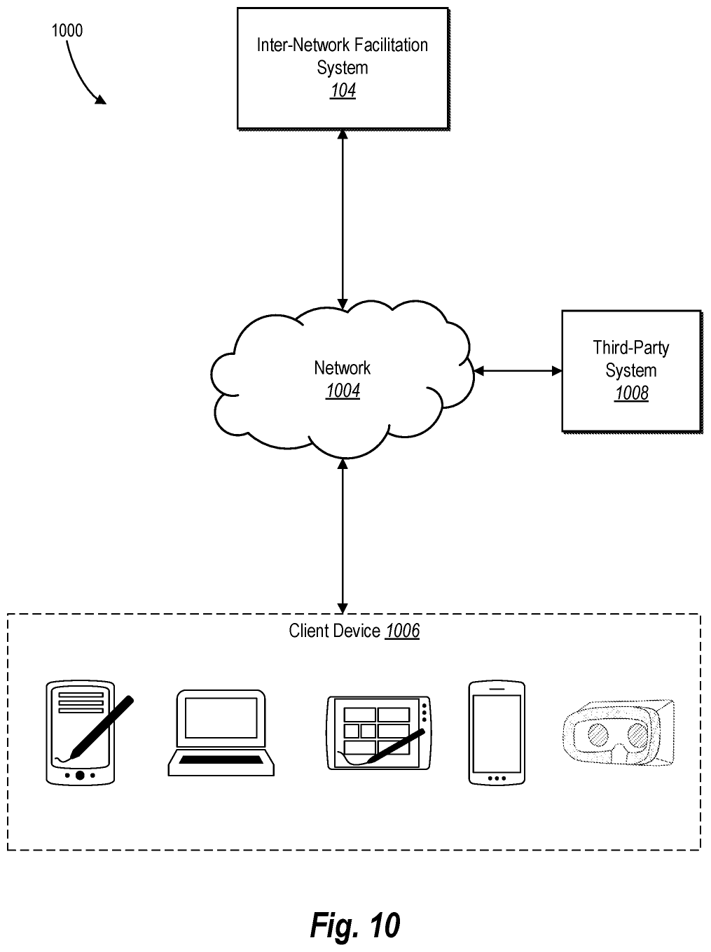

Additional detail regarding the feature family system will now be provided with reference to the figures. In particular, FIG. 1 illustrates a block diagram of a system environment for implementing a feature family system 102 in accordance with one or more embodiments. As shown in FIG. 1, the environment includes server(s) 106 housing the feature family system 102 as part of an inter-network facilitation system 104. The environment of FIG. 1 further includes client devices 108a-108n, an online banking system 112, and a database 116. In some embodiments, the environment includes additional systems connected to the feature family system 102, such as a credit processing system, an ATM system, or a merchant card processing system. The server(s) 106 can include one or more computing devices to implement the feature family system 102. Additional description regarding the illustrated computing devices (e.g., the server(s) 106, the client devices 108a-108n, the online banking system 112, and/or the database 116) is provided with respect to FIGS. 9-10 below.

As shown, the feature family system 102 utilizes the network 118 to communicate with the client devices 108a-108n, the online banking system 112, and/or the database 116. The network 118 may comprise any network described in relation to FIGS. 9-10. For example, the feature family system 102 communicates with the client devices 108a-108n to provide and receive information pertaining to feature families. Indeed, the inter-network facilitation system 104 or the feature family system 102 can receive an indication to generate a feature family and can provide information based on a prediction generated via a machine learning model utilizing the feature family. For example, feature family system 102 or the inter-network facilitation system 104 can, via machine learning predictions utilizing feature families, authorize or deny various user actions performed via the client devices 108a-108n, such as logins, account registrations, credit requests, transaction disputes, or online payments.

To generate and store feature families, in some embodiments, the feature family system 102 communicates with different components of the inter-network facilitation system 104, the online banking system 112, and/or the database 116 (or other interconnected systems). More specifically, the feature family system 102 determines feature values from raw data such as account balances for online banking accounts within the online banking system 112, login information including numbers of logins, time since first login, time since last login, account identifications, transaction information, and other feature values (e.g., from client devices 108a-108n, the inter-network facilitation system 104, the online banking system 112, and/or other systems) for various machine learning features to include within feature families to store within the feature family repository 114 at the database 116.

As indicated by FIG. 1, the client devices 108a-108n includes the client application 110. In many embodiments, the inter-network facilitation system 104 or the feature family system 102 communicates with the client devices 108a-108n through the client application 110 to, for example, receive and provide information including data pertaining to user actions for logins, account registrations, credit requests, transaction disputes, or online payments (or other client device information). In addition, the feature family system 102 generates or accesses machine learning features to include within feature families based on the client device information obtained from the client devices 108a-108n.

As indicated above, the inter-network facilitation system 104 or the feature family system 102 can provide (and/or cause the client devices 108a-108n to display or render) visual elements within a graphical user interface associated with the client application 110. For example, the inter-network facilitation system 104 or the feature family system 102 can provide a graphical user interface that includes a login screen and/or an indication of successful or unsuccessful login. In some cases, the feature family system 102 provides user interface information for a user interface for performing a different user action such as an account registration, a credit request, a transaction dispute, or an online payment. In some embodiments, the feature family system 102 determines where a user action (e.g., a login) is successful and/or permissible based on applying machine learning model to one or more machine learning features of a feature family.

Although FIG. 1 illustrates the environment having a particular number and arrangement of components associated with the feature family system 102, in some embodiments, the environment may include more or fewer components with varying configurations. For example, in some embodiments, the inter-network facilitation system 104 or the feature family system 102 can communicate directly with the client devices 108a-108n, the online banking system 112, and/or the database 116, bypassing the network 118. In these or other embodiments, the inter-network facilitation system 104 or the feature family system 102 can be housed (entirely on in part) on the client devices 108a-108n. Additionally, the inter-network facilitation system 104 or the feature family system 102 can include (e.g., house) the database 116 or communicate with the database 116 located externally from the server(s) 106 to store information such as feature families (e.g., within the feature family repository 114) and/or other information described herein.

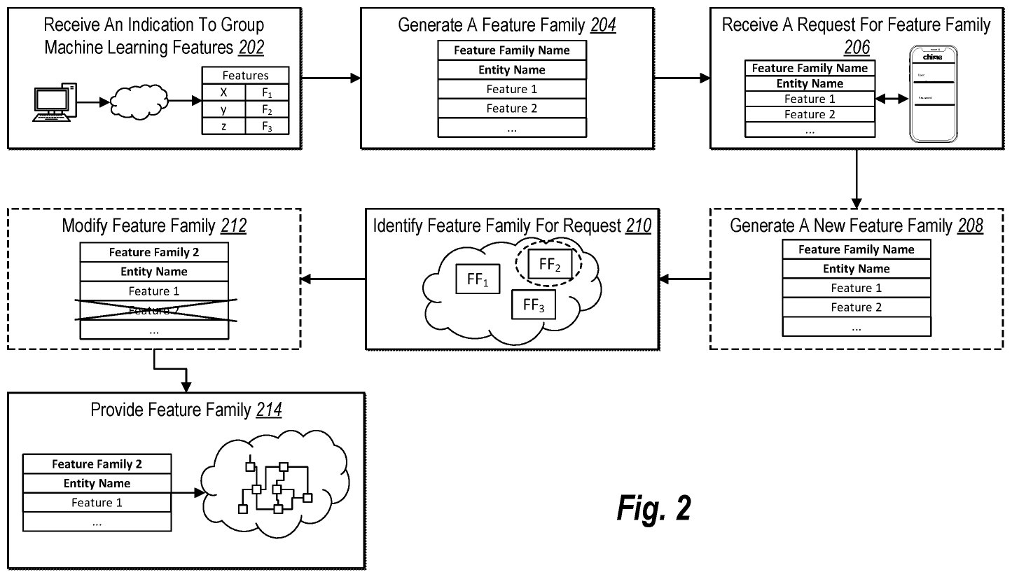

As mentioned, in certain embodiments, the feature family system 102 can generate and provide a feature family for generating machine learning predictions. In particular, the feature family system 102 can generate a feature family to store within a feature family repository (e.g., the feature family repository 114) and can retrieve machine learning features referenced by the feature family to provide to machine learning model for generating a prediction or inference. FIG. 2 illustrates an overview of a series of acts involved in generating and utilizing a feature family in accordance with one or more embodiments. Additional detail regarding the various acts described in relation to FIG. 2 is provided thereafter with reference to subsequent figures.

As illustrated in FIG. 2, the feature family system 102 performs an act 202 to receive an indication to group machine learning features. In particular, the feature family system 102 receives an indication from a client device (e.g., a data scientist device) to group one or more machine learning features together into a feature family. For instance, the feature family system 102 receives input from a data scientist device to generate a particular group of machine learning features that are used for generating a particular prediction and/or for training a particular machine learning model. In some cases, the feature family system 102 also receives an indication to generate or update the machine learning features for the feature family. For example, the feature family system 102 receives an indication to update feature values associated with one or more machine learning features.

As further illustrated in FIG. 2, the feature family system 102 performs an act 204 to generate a feature family. More specifically, the feature family system 102 generates a feature family in response to receiving the indication from the data scientist device to group one or more features together. As shown, the feature family system 102 generates a feature family to include a feature family name, an entity name, and feature names for the feature references included within (and referencing particular machine learning features) the feature family. The feature family system 102 generates a feature family to include feature references indicating respective network locations where features are generated and/or stored.

For instance, the feature family system 102 generates feature references to indicate network locations such as a client device data ingestion component that gathers data from client devices (e.g., the client devices 108a-108n) and/or generates features from the data. As an example, the feature family system 102 utilizes the client device data ingestion component to generate a machine learning feature for a client device (e.g., the client device 108a) such as “number of logins” where the feature family system 102 determines the number of logins (i.e., the feature value) to be 10 for the particular client device. In other examples, the feature family system 102 generates feature references for machine learning features from other network components such as a backend database (that stores various features and/or corresponding feature values from backend server data) or an engineering activity component (that stores various features and/or corresponding feature values from engineered data). Additional detail regarding different feature family, features, and their feature values is provided hereafter with reference to subsequent figures.

As illustrated in FIG. 2, the feature family system 102 further performs an act 206 to receive a request for a feature family. More particularly, the feature family system 102 receives a request from a particular device or network component, either as part of the inter-network facilitation system 104 or external to the inter-network facilitation system 104. For example, the feature family system 102 receives a request from a client device (e.g., the client device 108a) to perform a particular action associated with a user account within the inter-network facilitation system 104, such as a login attempt, a funds transfer, an account registration, a credit request, a transaction dispute, an online payment, or some other action performable via the client application 110. In some cases, the feature family system 102 receives a request from an engineering device, where the request indicates a particular feature family that accompanies the action or that is required to generate a particular machine learning prediction associated with the request.

In certain embodiments, in response to the request, the feature family system 102 performs an act 208 to generate a new feature family. Indeed, in certain cases, the feature family system 102 intelligently generates a new feature family that does not already exist within a feature family repository (e.g., the feature family repository 114) in response to receiving a feature family request. For example, the feature family system 102 determines that no feature family exists that would fulfill the request or that no feature family is stored within a repository that would fulfill the request. Additionally, the feature family system 102 generates a new feature family to include feature references for machine learning features that are indicated by, or that would fulfill, the request. In some cases, the feature family system 102 determines or identifies machine learning features that would fulfill (or that otherwise correspond to) the request by, for instance, determining features that, when applied to a machine learning model, would result in a prediction associated with the request. The feature family system 102 further generates a feature family to include feature references for the identified machine learning features.

As further illustrated in FIG. 2, the feature family system 102 performs an act 210 to identify a feature family for the request. To elaborate, the feature family system 102 identifies a feature family (e.g., generated via the act 204 or the act 208) from a feature family repository (e.g., the feature family repository 114). In some cases, the feature family system 102 determines a feature family that is indicated directly by the request (e.g., where the request specifies a particular feature family). In these or other cases, the feature family system 102 determines similarity scores in relation to a requested feature family for one or more stored feature families in a feature family repository. The feature family system 102 further selects a feature family with a highest similarity score as a feature family to utilize or provide in response to the request.

In certain cases, the feature family system 102 identifies a feature family by determining a feature family that, when utilized via an appropriate machine learning model, would generate a prediction corresponding to the request received via the act 206. For example, the feature family system 102 identifies a feature family (or particular machine learning features) that, when analyzed via a machine learning model, would generate an authentication prediction (e.g., a prediction of verification or denial) for an action such as a login, a funds transfer, an account registration, a credit request, a transaction dispute, or an online payment. In some embodiments, the feature family system 102 identifies a feature family that includes the machine learning features that would result in a machine learning prediction for the request. As shown, from the three illustrated feature families, the feature family system 102 identifies the feature family FF₂ for the request received via the act 206.

In some embodiments, as shown in FIG. 2, the feature family system 102 performs an act 212 to modify a feature family. More specifically, the feature family system 102 intelligently modifies (or provides a recommendation to modify) a feature family to add or remove machine learning features. For instance, the feature family system 102 analyzes historical feature family requests and machine learning features that were provided or utilized in response to the historical requests. In some cases, the feature family system 102 compares machine learning features from previous requests of the same type (e.g., requests to perform the same action or apply the same machine learning model). Based on comparing the historically utilized machine learning features for previous iterations of the same feature family identified for a request (e.g., the request received via the act 206), the feature family system 102 determines machine learning features to add or remove from the identified feature family.

For example, the feature family system 102 identifies one or more machine learning features that are unused or used in less than a threshold percent of previously identified feature families as features to remove. As another example, the feature family system 102 identifies, as features to add to the feature family, one or more machine learning features historically added to (or used in addition to) at least a threshold number of previous feature families associated with the same type of request (e.g., for application of the same machine learning model and/or to perform the same action). As shown, the feature family system 102 removes Feature 2 from the feature family as an underused feature based on previously identified feature families.

As further illustrated in FIG. 2, the feature family system 102 performs an act 214 to provide a feature family. In particular, the feature family system 102 provides the feature family identified via the act 210 (and modified via the act 212). For example, the feature family system 102 provides the feature family to a machine learning model indicated by (or determined to be associated with) the request received via the act 206. Indeed, in one or more embodiments, determines a machine learning model associated with the request by identifying a machine learning model that will generate a prediction corresponding to a particular action.

Thus, the feature family system 102 retrieves the machine learning features from their respective network locations, as indicated by the feature references within the feature family and provides the machine learning features to a machine learning model. The feature family system 102 also utilizes the machine learning model to generate a prediction according to the features associated with the feature family (e.g., to authenticate or prevent a login, a funds transfer, an account registration, a credit request, a transaction dispute, or an online payment). The feature family system 102 thus quickly accesses machine learning features for generating prediction of fraudulent activity to, for example, prevent account takeovers. In some cases, the feature family system 102 provides the feature family to an engineering device that later applies the feature family for training or inference of a machine learning model.

As a brief example of preventing an account takeover via the process illustrated in FIG. 2, in response to receiving the request via the act 206, the feature family system 102 performs an authentication or validation procedure that involves: i) identifying or determining a feature family associated with the requested action (e.g., the act 210), ii) accessing the feature family from a feature family repository, iii) retrieving machine learning features referenced by the feature family (from their respective network locations), iv) providing the machine learning features to a machine learning model (e.g., the act 214), v) generating a prediction (e.g., an authentication prediction determining whether to permit or deny the requested action) via the machine learning model, and vi) providing a response to the client device either permitting or denying the requested action based on the generated prediction.

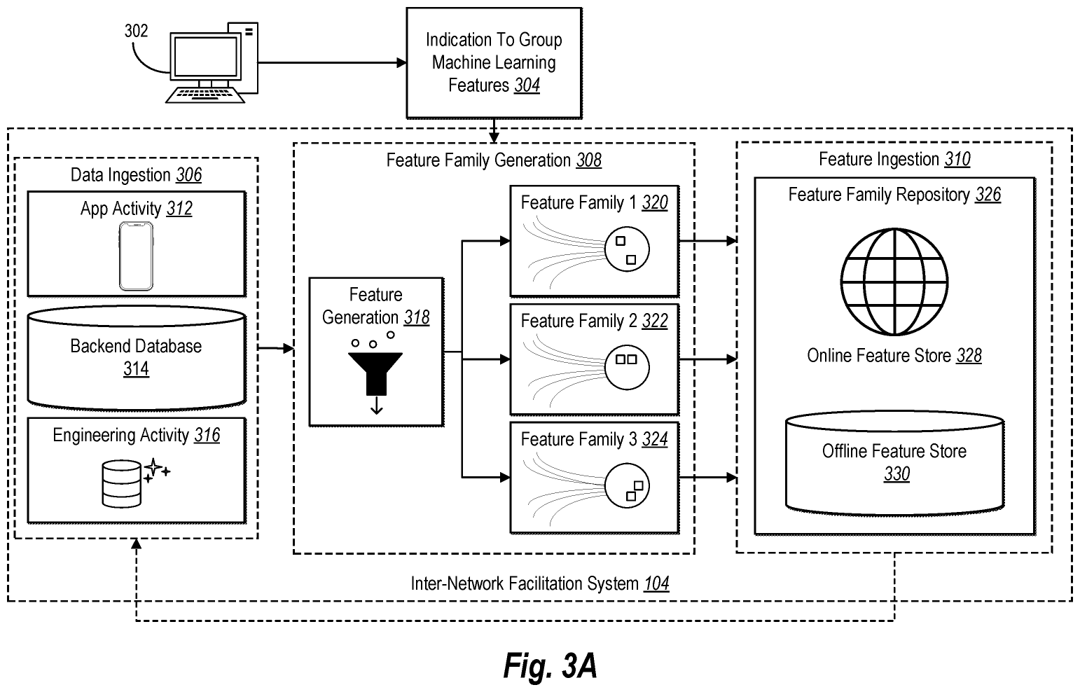

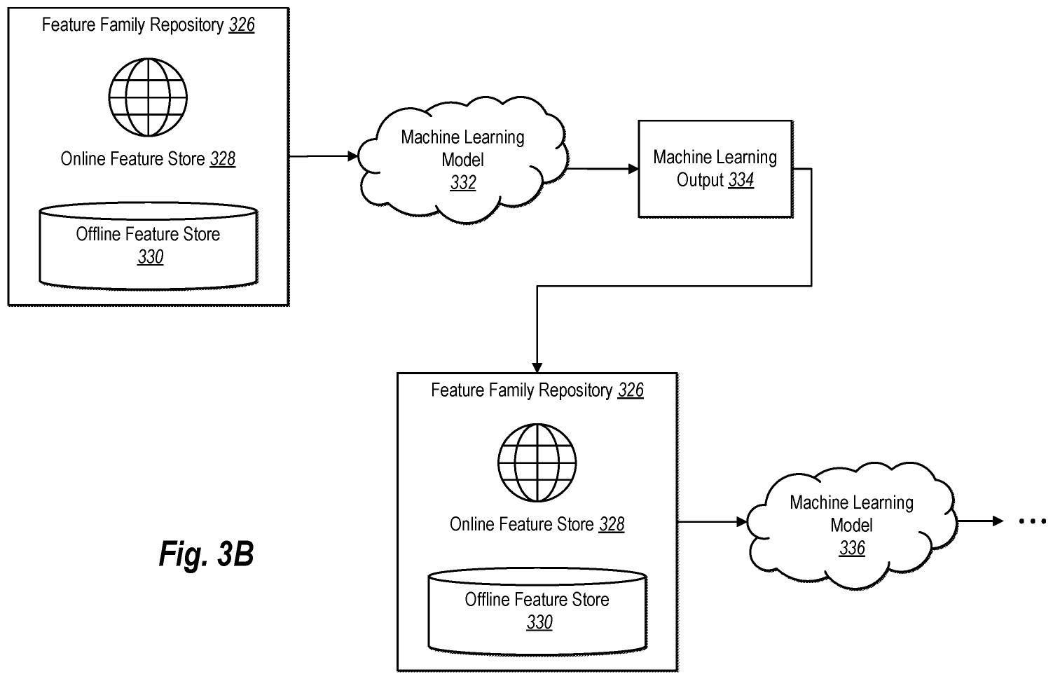

As mentioned above, in certain embodiments, the feature family system 102 generates feature families that indicate machine learning features generated and/or stored across various network components of the inter-network facilitation system 104. In particular, the feature family system 102 generates feature families that include online features and/or offline features that each include feature values determined via raw data gathered from client devices (e.g., the client devices 108a-108n), backend servers, user accounts, and/or external sources (e.g., the online banking system 112). FIG. 3A illustrates generating and storing feature families utilizing different network components of the inter-network facilitation system 104 in accordance with one or more embodiments.

As illustrated in FIG. 3A, the feature family system 102 receives an indication 304 to group machine learning features from a data scientist device 302. For instance, the feature family system 102 receives the indication 304 that specifies one or more machine learning features to group together into a feature family. Indeed, in some cases, the data scientist device 302 defines a feature family to include feature references for particular machine learning features that belong together or that are often used together to generate a prediction or to train a machine learning model.

In response to receiving the indication 304, the feature family system 102 generates a corresponding feature family. As shown, to generate and store a feature family, the feature family system 102 performs a three-part process involving: i) data ingestion 306, ii) feature family generation 308, and iii) feature ingestion 310. Regarding the data ingestion 306, the feature family system 102 gathers raw data from various network components including an app activity component 312, a backend database 314, and an engineering activity component 316.

To elaborate, the feature family system 102 gathers raw data from the app activity component 312. For example, the feature family system 102 gathers app activity data from the client devices 108a-108n such as logins, transaction amounts (e.g., for payments or transfers), sender identifications, recipient identifications, IP addresses, device identifications, geographic locations, cellular networks used, timestamps of various actions, and/or clicks or other interactions with various elements of the client application 110.

In addition, the feature family system 102 gathers backend data from the backend database 314. In particular, the feature family system 102 gathers data such as account ages, usernames, passwords, email addresses associated with user accounts, numbers of transactions, and/or types of transactions (e.g., deposits, payments, or transfers). Further, the feature family system 102 gathers engineered data from the engineering activity component 316. For example, the feature family system 102 gathers engineered data such as average transaction amounts (e.g., determined by totaling transaction amounts and dividing by the number of transactions), numbers of negative balance days, numbers of time zones used over a previous time period (e.g., 30 days), numbers of sessions over a previous time period (e.g., 7 days), numbers of zero balance days in a previous time period (e.g., the first 45 to 90 days), and/or other engineered data determined by combining two or more pieces of raw data.

In some cases, the feature family system 102 performs the data ingestion 306 in real time (or near real time) with a request to generate or utilize a feature family. For instance, the feature family system 102 generates low latency features in real time as data is ingested via app activity 312, engineering activity 316, or from some other source. In some cases, the feature family system 102 thus performs the data ingestion 306 and the feature family generation 308 together in real time.

Upon performing the data ingestion 306, the feature family system 102 performs the feature family generation 308. To elaborate, the feature family system 102 generates individual machine learning features and groups the machine learning features into feature families. Indeed, the feature family system 102 performs the feature generation 318 to generate feature values (for machine learning features) from the raw data gathered via the data ingestion 306. For example, the feature family system 102 utilizes translation, encoding, or other functions to generate app-related machine learning features and/or client-device-related machine learning features from the data gathered via the app activity component 312. In addition, the feature family system 102 generates backend database features from data gathered via the backend database 314. Further, the feature family system 102 generates engineering activity features from data gathered via the engineering activity component 316.

As an example, the feature family system 102 generates an app-related machine learning feature such as “number of logins” for a client device (e.g., the client device 108a) and determines a feature value of 7 logins for the client device 108a based on login attempts received from the client device 108a. As an example of an engineered feature, the feature family system 102 generates an engineering activity feature such as “average transaction amount” for the client device 108a and determines a feature value of $23 as the average transaction amount for the client device 108a based on the number of transactions received from the client device 108a and the amounts of those transactions.

In some embodiments, the feature family system 102 generates online features and offline features. Offline features can include features such as a number of transactions associated with a user account, a number of disputed transfers, a time since first transfer, a time since last transfer, or other features from offline data not gathered in real time (or near real time). In these or other embodiments, the feature family system 102 generates online features from real-time data and/or nearline data (e.g., near real-time data). Real-time features can include features such as a sender user identification, a receiver user identification, a transfer amount, a sender device identification, and a sender device IP address. Nearline features can include features such as a number of logins in the past hour, an amount transferred in the last hour, an amount transferred in the last 30 minutes, or a number of transactions in the last hour.

In addition to the feature generation 318, the feature family system 102 further generates feature families from the generated machine learning features. Particularly, the feature family system 102 generates feature families that include machine learning features or that include feature references indicating locations where machine learning features are stored (or from where the feature values for the machine learning features can be obtained). For instance, the feature family system 102 generates a feature family 320 (“Feature Family 1”) to include feature references to one or more of the app activity component 312, the backend database 314, or the engineering activity component 316. Thus, the feature family system 102 can access the machine learning features of feature family 320 and their corresponding feature values from each of the respective network locations upon request. Likewise, the feature family system 102 generates a feature family 322 (“Feature Family 2”) and a feature family 324 (“Feature Family 3”) that include feature references to one or more network locations corresponding to machine learning features. As an example, the feature family system 102 generates a feature family based on receiving the indication 304 to group machine learning features.

In some cases, the feature family system 102 intelligently generates feature families by determining relationships between features and grouping machine learning features within a threshold similarity of each other within a common feature family. In other cases, the feature family system 102 intelligently generates feature families by analyzing historical feature family requests and/or historical indications to generate feature families to identify machine learning features that are often (e.g., above a threshold frequency or a threshold number of times) requested together and/or implemented together via a machine learning model.

As further illustrated in FIG. 3A, in addition to the data ingestion 306 and the feature family generation 308, the feature family system 102 performs the feature ingestion 310. More specifically, the feature family system 102 stores the feature families (e.g., the feature family 320, the feature family 322, and the feature family 324) within a network component called a feature family repository 326 (e.g., the feature family repository 114). As shown, the feature family repository 326 includes additional network components such as an online feature store 328 and an offline feature store 330.

In some cases, feature family system 102 stores feature families including online features in the online feature store 328 and stores feature families include offline features in the offline feature store 330. In other cases, a feature family is a hybrid feature family and includes both online and offline features. Thus, the feature family system 102 stores a hybrid feature family within the feature family repository 326. In certain embodiments, the feature family system 102 stores the corresponding machine learning features and their feature values within the feature family repository 326. Thus, in some embodiments, the feature references within a feature family indicate the online feature store 328 or the offline feature store 330 where the machine learning features are stored.

In one or more embodiments, the feature family system 102 utilizes stored features and/or feature families as a resource from which to generate additional machine learning features. For example, the feature family system 102 utilizes the feature family repository 326 as a source for the data ingestion 306. Indeed, the feature family system 102 accesses a stored feature family and generates additional features from the feature family (e.g., via the feature generation 318 of the feature family generation 308). Thus, in some cases, the feature family system 102 generates additional feature families for storage into the feature family repository 326 based on previously generated and stored feature families (as indicated by the dashed arrow from 310 to 306).

In certain embodiments, the feature family system 102 utilizes predictions or other outputs from a machine learning model as features for another machine learning model. In particular, the feature family system 102 daisy chains the generation of feature families such that a generated output from one machine learning model is a feature (e.g., as part of a feature family) for another machine learning model. FIG. 3B illustrates linking feature families of machine learning models in accordance with one or more embodiments.

As illustrated in FIG. 3B, the feature family system 102 accesses a feature family from the feature family repository 326 to provide to a machine learning model 332. In turn, the machine learning model 332 generates a machine learning output 334. For instance, the machine learning output 334 can be a final generated prediction from the machine learning model 332 or an intermediate output from one or more internal components (e.g., layers, branches, or neurons) of the machine learning model 332. The feature family system 102 can further store the machine learning output 334 in the feature family repository 326 to use as a feature (or multiple features, depending on the output) within a feature family.

As further illustrated in FIG. 3B, the feature family system 102 can provide a feature family that includes the machine learning output 334 as a feature. Indeed, the feature family system 102 can, in response to a request for a feature family that includes the machine learning output 334, provide the feature family to a machine learning model 336. In turn, the machine learning model 336 generates an additional machine learning output from the feature family (based at least in part on the machine learning output 334 from the machine learning model 332). As shown, this daisy chain process can continue for additional machine learning outputs and machine learning models, where the feature family system 102 generates feature family from machine learning outputs to provide to subsequent machine learning models.

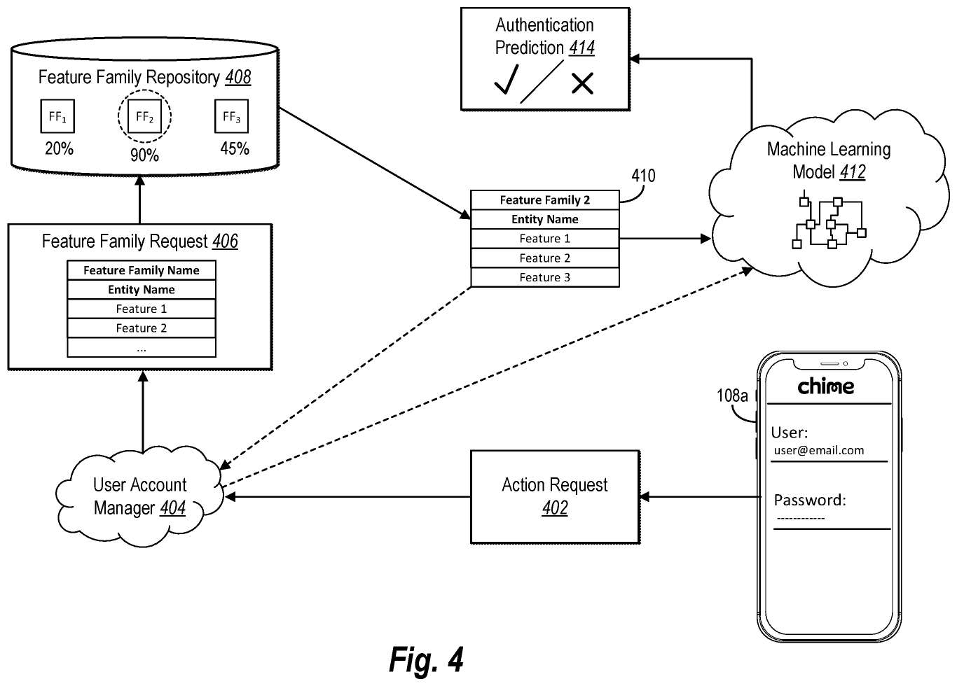

As mentioned above, in certain described embodiments, the feature family system 102 receives a request for a feature family. In particular, the feature family systems 102 receives a feature family request in response to a client device action, whereupon the feature family system 102 identifies a corresponding feature family and utilizes a machine learning model to generate, from the feature family, an authentication prediction for the client device action. FIG. 4 illustrates an example of receiving a feature family request and applying a machine learning model to a feature family corresponding to the request in accordance with one or more embodiments.

As illustrated in FIG. 4, a user account manager 404 (e.g., as part of the feature family system 102 or the inter-network facilitation system 104) receives an action request 402 from a client device 108a. For instance, the client device 108a provides the action request 402 in the form of a request to perform a particular client device action such as a login, a funds transfer, an account registration, a credit request, a transaction dispute, or an online payment. In response to the action request 402, the user account manager 404 determines or identifies a feature family corresponding to the action request 402. For example, the user account manager 404 identifies a feature family that is required to generate an authentication prediction to either approve or reject the action request 402.

In turn, the user account manager 404 generates and provides a feature family request 406. Indeed, the user account manager 404 generates a feature family request that indicates the feature family for generating a machine learning prediction associated with the action request 402. As shown, the user account manager 404 generates the feature family request 406 to indicate a feature family name, an entity name, and one or more machine learning feature names. In some embodiments, the feature family system 102 receives a feature family request from an engineer client device for implementation via a machine learning model to train a machine learning model or generate a machine learning prediction via a machine learning model.

As further illustrated in FIG. 4, in response to receiving the feature family request 406, the feature family system 102 accesses a feature family repository 408 (e.g., the feature family repository 326 or 114) to determine or identify a feature family corresponding to the feature family request 406. In some cases, the feature family system 102 determines or identifies a feature family that exactly matches the feature family indicated in the feature family request 406. For instance, the feature family system 102 compares stored feature family names, stored entity names, and/or stored machine learning feature names for stored feature families with feature family names, entity names, and/or machine learning feature names indicated by the feature family request 406.

In one or more embodiments, the feature family system 102 determines similarity scores for stored feature families within the feature family repository 408. In particular, the feature family system 102 determines that no stored feature family matches the feature family request 406 and instead determines similarity scores for the stored feature families. For example, the feature family system 102 compares feature family names, entity names, and/or feature names to determines a percentage match between a stored feature family and the feature family request 406. In some embodiments, the feature family system 102 selects a feature family that has (a threshold number of) matching machine learning feature names in relation to the feature family request 406 but that has a different feature family name (and/or entity name) than the feature family request 406.

In the same or other embodiments, the feature family system 102 determines similarity scores based on historical data. For instance, the feature family system 102 determines and compares historical information indicating previous feature families used for the same (type of) client device action as the action request 402 and/or implemented by the same type of machine learning model as the machine learning model 412. In some cases, the feature family system 102 selects a feature family for the feature family request 406 by identifying a feature family that satisfies a threshold similarity score and/or that has a highest similarity score in relation to the feature family request 406. As shown, the feature family system 102 determines a similarity score of 20% for the feature family FF₁, a similarity score of 90% for the feature family FF₂, and a similarity score of 45% for the feature family FF₃. The feature family system 102 thus selects the feature family FF₂ as corresponding to the feature family request 406.

Indeed, the feature family system 102 selects the feature family 410 (FF₂) to provide to a machine learning model 412. In some embodiments, the feature family system 102 determines or selects the machine learning model 412 from among a plurality of candidate machine learning models. Specifically, the feature family system 102 determines that the machine learning model 412 is trained to generate predictions corresponding to the action request 402. In some cases, the feature family system 102 determines that the machine learning model 412 is trained on machine learning features that match (or that are similar to) those indicated by the feature family 410. For different client device actions, the feature family system 102 selects different machine learning models and, consequently, different feature families.

As illustrated in FIG. 4, the feature family system 102 selects the machine learning model 412 to generate a prediction for the action request 402. In turn, the feature family system 102 provides the feature family 410 (or the machine learning model features indicated by the feature family 410) to the machine learning model 412. For instance, the feature family system 102 retrieves the machine learning features from the respective network locations indicated by the feature references of the feature family 410. In some cases, the feature family system 102 retrieves feature values for the machine learning features in near real time with receipt of the action request 402, including a number of login attempts (in a previous time period), an IP address, a device identification, and/or other information.

In turn, the machine learning model 412 generates an authentication prediction 414 from the machine learning features. Indeed, the machine learning model 412 generates the authentication prediction 414 that indicates a prediction of whether or not the action request 402 is a genuine action request from an actual client device operated by an authorized user or is a synthetic action request such as a registration of a synthetic account or an account takeover attempt from a bot or other malicious actor. As shown, in some embodiments, the feature family system 102 provides the feature family 410 to a requesting device or network component such as the user account manager 404 (and not directly to the machine learning model 412). The user account manager 404, in turn, then provides the feature family 410 to the machine learning model 412.

Based on generating the authentication prediction 414, in some embodiments, the feature family system 102 authorizes or prevents the action request 402. For example, the feature family system 102 provides the authentication prediction 414 to the user account manager 404, whereupon the user account manager 404 provides an indication of authorization or denial to the client device 108a. Thus, the feature family system 102 either authorizes or prevents the client device 108a in performing the action request 402 based on the authentication prediction 414.

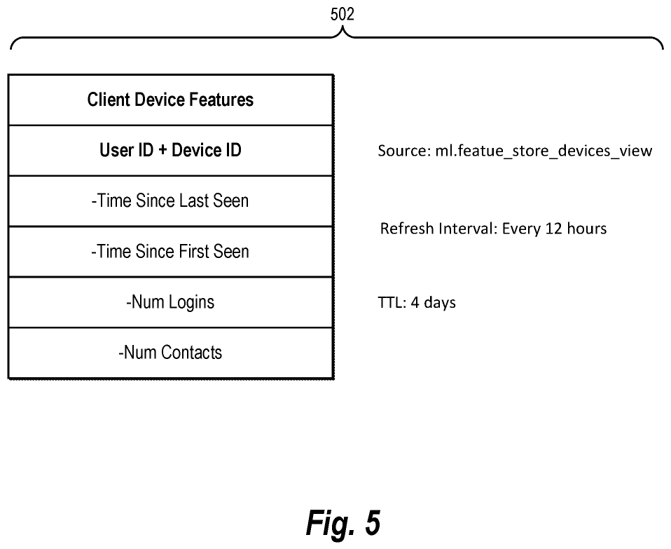

As mentioned, in certain described embodiments, the feature family system 102 generates a feature family that includes particular information. Specifically, the feature family system 102 generates a feature family to include a feature family name, an entity name, one or more machine learning feature names, and other information. FIG. 5 illustrates an example feature family in accordance with one or more embodiments.

As illustrated in FIG. 5, the feature family 502 includes a feature family name of “Client Device Features.” The feature family name indicates information about the feature family such as a type of device associated with the feature family 502, a type of machine learning model associated with the feature family 502, or some other information. In addition, the feature family 502 includes multiple entity names of “User ID” and “Device ID.” In some cases, a feature family can include a single entity name. The entity name indicates the network component or device from where data for the machine learning features of the feature family 502 are gathered or determined.

Further, the feature family 502 includes feature names for four different machine learning features, such as “Time Since Last Seen,” “Time Since First Seen,” “Num Logins,” and “Num Contacts.” The “Time Since Last Seen” represents a time that has elapsed since the user account or client device previously logged in. The “Time Since First Seen” represents a time that has elapsed since the user account or client device first logged in. The “Num Logins” represents a number (e.g., a total cumulative number or a number in a particular time period) of logins associated with the user account or client device. The “Num Contacts” represents a total number of contacts associated with the user account or client device. Additional or alternative machine learning features (and corresponding names) are possible, as described herein.

As further illustrated in FIG. 5, the feature family 502 includes a source, a refresh interval, and a time to live (“TTL”). To elaborate, the source indicates a network component or a network location where the machine learning feature (or corresponding feature values) are generated or stored. As shown, the source for the feature family 502 is “ml.feature_store_devices_view” which indicates a particular network location within the inter-network facilitation system 104. In some embodiments, a feature family may indicate multiple sources of machine learning features associated with the feature family are stored in, or generated from, different network locations.

In addition, the refresh interval indicates a periodic (or non-periodic) interval that the feature family system 102 utilizes to update or refresh the feature family 502 (or the machine learning features indicated by the feature family 502). For example, the feature family system 102 re-accesses the network component(s) where the feature values are determined for machine learning features to re-determine the feature values for the different machine learning features. In certain cases, the feature family system 102 updates the entire feature family 502 (including all features) based on the refresh interval. In other cases, the feature family system 102 updates certain features according to the refresh interval while other features remain static (or update according to a different interval).

In some embodiments, the feature family system 102 updates feature values based on detecting trigger events. For instance, the feature family system 102 detects a trigger event such as an action request (e.g., the action request 402), an indication to generate a new feature family, an indication to modify a feature family, a modification of a machine learning model, a software update for the client application 110, or some other trigger event. Indeed, trigger events can include batch events, scheduled events, and or user-driven events. The feature family system 102 further updates the features values in response to the trigger event. For example, the feature family system 102 updates a feature value for a phone number of a user account in response to detecting a change to the phone number entered via a client device. In certain cases, the feature family system 102 updates specific features based on individualized trigger events where, for example, one feature has certain trigger events to initiate an update and another feature has a different trigger event that initiates an update to a different feature. By selectively refreshing features based on trigger events, in some embodiments, the feature family system 102 preserves computing resources that would otherwise be expended refreshing all features on the same periodic basis (even where many of the features remain unchanged and do not need to be refreshed).

As shown, the refresh interval for the feature family 502 is 12 hours, so the feature family system 102 updates the feature values for the machine learning features indicated by the feature family 502 once every 12 hours. In some cases, a feature family includes multiple different refresh intervals (or some that are periodic and some that are based on trigger events) for different machine learning features and indicated by the feature family. Refresh intervals can be more granular or less granular than the example illustrated. Additionally, the feature family system 102 can update features of a feature family on an incremental basis (e.g., via upserts that combine updates and inserts of feature values) or batch updates for cost efficient performance, to reduce computational requirements of feature updates (e.g., up to 60% or 90% in some cases).

As further illustrated in FIG. 5, the TTL indicates a lifespan or shelf life associated with the feature family 502 (or the machine learning features indicated by the feature family 502). In particular, the TTL indicates a time period that the feature values of the machine learning features within the feature family 502 are valid for before they go stale. For example, some machine learning features have feature values that expire quickly (e.g., within a week), while other machine learning features have feature values that last longer (e.g., a month or six months) or that do not go stale (e.g., time since first seen). In some cases, a feature family includes multiple different TTLs for different machine learning features indicated by the feature family. The feature family system 102 further re-determines feature values for machine learning features that go stale upon expiration of their TTL.

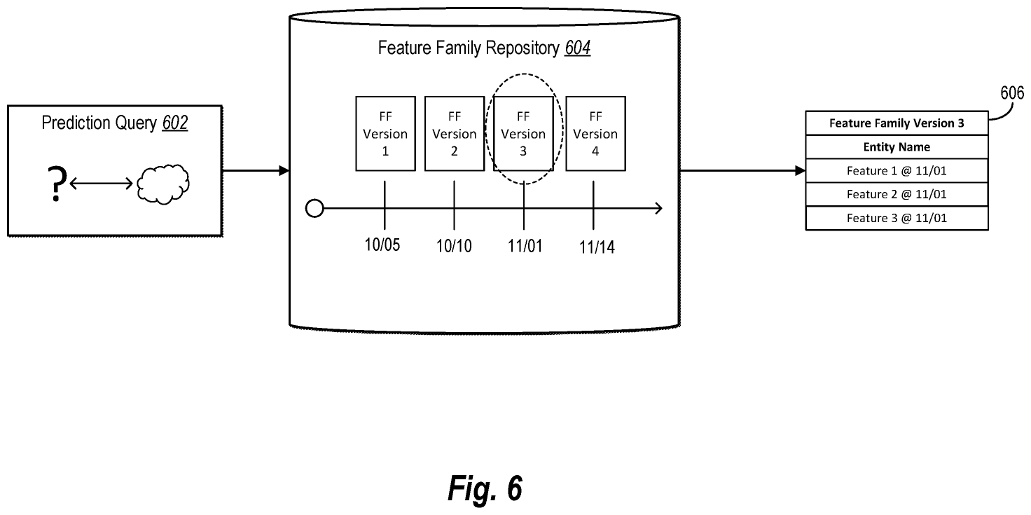

As mentioned above, in certain described embodiments, the feature family system 102 traces a lineage of feature values for a machine learning feature to determine a feature value at a particular point in time. In particular, the feature family system 102 receives a prediction query requesting one or more feature values (for a feature family) that were previously used to generate a machine learning prediction. FIG. 6 illustrates an example of determining feature values for a feature family at a particular point in time in accordance with one or more embodiments.

As illustrated in FIG. 6, the feature family system 102 receives a prediction query 602. In particular, the feature family system 102 receives a query (e.g., from an engineer client device) requesting information pertaining to how a previous machine learning prediction was generated. For example, the feature family system 102 receives the prediction query 602 that requests historical feature values at a particular point in time when a feature family was utilized to generate a previous machine learning prediction. In response, the feature family system 102 accesses a feature family repository 604 (e.g., the feature family repository 114, 326, and/or 408) that includes feature families and that further includes historical feature values for individual machine learning features for specific points in time (e.g., for every point in time that feature values are updated or for every point in time a feature family is requested or utilized). As shown, the feature family system 102 stores four (or more) versions of a particular feature family (“FF”) with different feature values for different points in time (e.g., dates): 10/05, 10/10, 11/01, and 11/14. In some embodiments, the points in time are more granular and can, for example, include hours, minutes, and seconds.

As shown, the feature family system 102 identifies the feature family “FF” in response to the prediction query 602. Specifically, the feature family system 102 determines a feature family indicated by the prediction query 602 and further determines a specific version of the feature family indicated by the prediction query 602. For example, the feature family system 102 determines that the prediction query 602 requests feature values for the feature family that were used to generate a particular prediction on 11/01. Accordingly, the feature family system 102 retrieves the historical version of the feature family that includes the feature values from 11/01 (“FF Version 3”). As shown, the feature family system 102 selects the historical feature family 606 that includes a feature family name, an entity name, and machine learning features (or feature references indicating machine learning features) including feature values from 11/01.

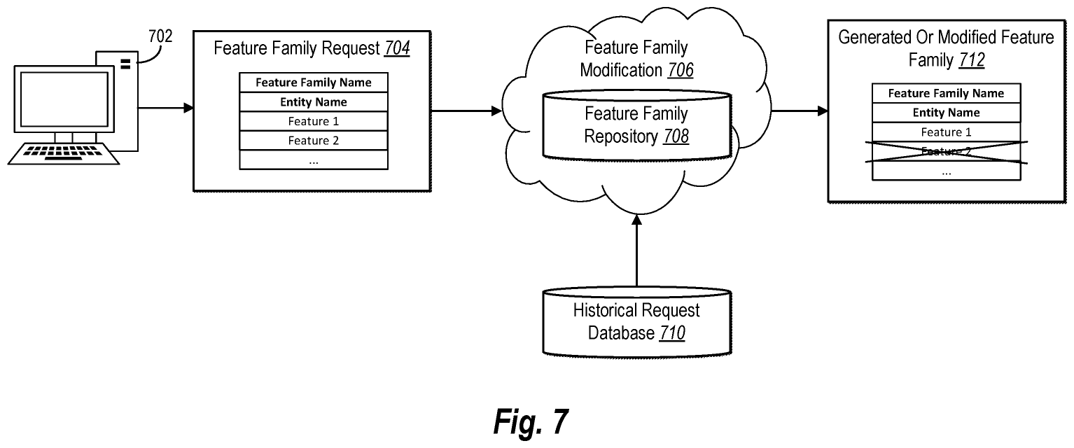

As mentioned, in certain embodiments, the feature family system 102 intelligently generates or modifies a feature family. In particular, instead of requiring express generation of a feature family via a data scientist device, the feature family system 102 generates or modifies a feature family based on information from a feature family request. FIG. 7 illustrates an example flow whereby the feature family system 102 generates or modifies a feature family in accordance with one or more embodiments.

As illustrated in FIG. 7, the feature family system 102 receives a feature family request 704 from an engineer device 702. For example, the feature family system 102 receives the feature family request 704 for a particular feature family for implementing or training a machine learning model. In some cases, the feature family system 102 receives a feature family request from a different source such as the user account manager 404 or a different component of the inter-network facilitation system 104 that utilizes machine learning features.

In response to receiving the feature family request 704, the feature family system 102 performs a feature family modification 706 (or a feature family generation). To modify a feature family stored in a feature family repository 708 (e.g., the feature family repository 114, 326, 408, and/or 604), the feature family system 102 analyzes a historical request database 710. Indeed, in some embodiments, the feature family system 102 stores historical feature family requests in the historical request database 710 and determines relationships between the historical feature family requests, requesters (e.g., the engineer device 702 or other requesting component) requesting the feature families, actions associated with the feature families (e.g., client device actions), and/or machine learning models applied to (or trained utilizing) the feature families.

For example, the feature family system 102 determines a threshold number (or threshold percentage) of previous machine learning predictions that utilized the same feature family as the feature family request 704 (and/or that were used for the same action or prediction) but that never used a particular machine learning feature within the feature family. The feature family system 102 thus determines to modify (or provide a notification to recommend modifying) the feature family by removing the previously unused machine learning feature (or its feature reference).

For instance, the feature family system 102 determines feature names for machine learning features indicated within a plurality of previous requests for a feature family (e.g., where each of the plurality of requests indicate less than all stored feature names associated with the feature family). In addition, the feature family system 102 compares the feature names of the previous requests with the stored feature names of the requested feature family. Based on comparing the requested feature names the stored feature names, the feature family system 102 determines one or more machine learning features that are named in less than a threshold percent of the plurality of previous requests for the feature family (e.g., indicating that the feature is likely not useful in many cases). Thus, the feature family system 102 generates an additional feature family to exclude a feature reference for the machine learning feature that is named in less than a threshold percent of the plurality of requests.

As another example, the feature family system 102 identifies a threshold number (or threshold percentage) of previous machine learning predictions that required additional machine learning features (and that were used for the same action or prediction). The feature family system 102 thus determines to modify the feature family by adding feature references for the additional machine learning features. Alternatively, the feature family system 102 determines to generate a new feature family that includes the additional feature references or machine learning features.

In some embodiments, the feature family system 102 utilizes a machine learning model such as a neural network to generate a new or modified feature family. For example, the feature family system 102 inputs the feature family request 704 (and/or an indication of a client device action or prediction for applying a feature family) into a feature family prediction machine learning model, whereupon the feature family prediction machine learning model analyzes the input information to generate a predicted feature family (including feature references for particular machine learning features) corresponding to the feature family request 704 (and/or the indication of the action or prediction). As shown, the feature family system 102 generates the generated or modified feature family 712 based on historical feature family requests (e.g., by removing Feature 2).

In one or more embodiments, the feature family system 102 automatically (e.g., without user input) determines weights associated with one or more machine learning features of a feature family. To elaborate, the feature family system 102 determines weights that emphasize one feature or another by a certain degree when generating a prediction via a machine learning model. For example, the feature family system 102 analyzes weights determined for features used to generate previous predictions. In some cases, the feature family system 102 accesses weights for features of the same feature family used in the past to generate, via the same machine learning model, the same prediction for the same type of task or action. For a given machine learning features, the feature family system 102 further utilizes a weight from a previous instance to assign a weight for generating a new prediction. In some cases, the feature family system 102 combines (e.g., averages) previous weights for a given feature and assigns the historical average weight to a machine learning feature for a new prediction.

The components of the feature family system 102 can include software, hardware, or both. For example, the components of the feature family system 102 can include one or more instructions stored on a computer-readable storage medium and executable by processors of one or more computing devices (e.g., the computing device server(s) 106, the client devices 108a-108n, and/or a third-party device). When executed by the one or more processors, the computer-executable instructions of the feature family system 102 can cause a computing device to perform the methods described herein. Alternatively, the components of the feature family system 102 can comprise hardware, such as a special purpose processing device to perform a certain function or group of functions. Additionally or alternatively, the components of the feature family system 102 can include a combination of computer-executable instructions and hardware.

Furthermore, the components of the feature family system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the feature family system 102 may be implemented as part of a stand-alone application on a personal computing device or a mobile device. Alternatively or additionally, the components of the feature family system 102 may be implemented in any application that allows creation and delivery of marketing content to users, including, but not limited to, various applications.

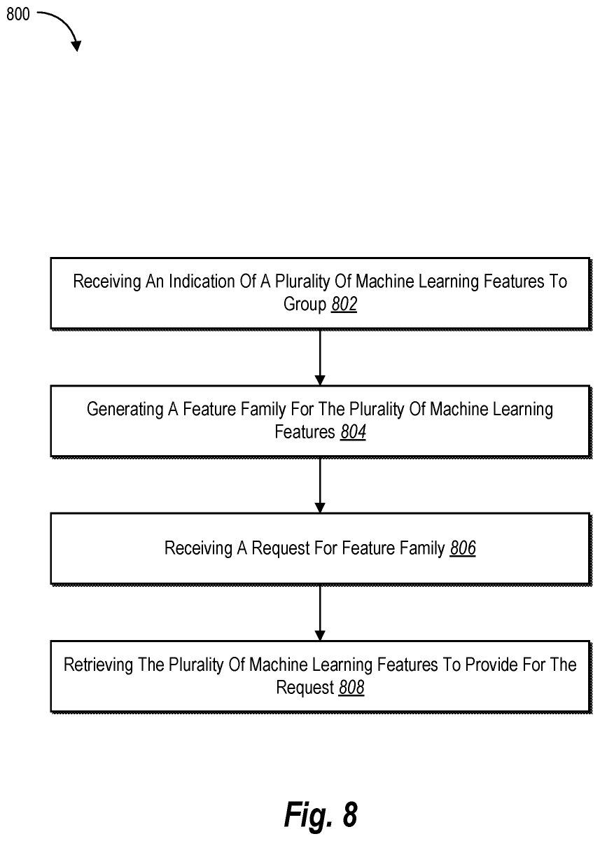

FIGS. 1-7, the corresponding text, and the examples provide a number of different systems, methods, and non-transitory computer readable media for generating, storing, retrieving, and providing feature families for machine learning features. In addition to the foregoing, embodiments can also be described in terms of flowcharts comprising acts for accomplishing a particular result. For example, FIG. 8 illustrates a flowchart of an example sequence of acts in accordance with one or more embodiments.

While FIG. 8 illustrates acts according to some embodiments, alternative embodiments may omit, add to, reorder, and/or modify any of the acts shown in FIG. 8. The acts of FIG. 8 can be performed as part of a method. Alternatively, a non-transitory computer readable medium can comprise instructions, that when executed by one or more processors, cause a computing device to perform the acts of FIG. 8. In still further embodiments, a system can perform the acts of FIG. 8. Additionally, the acts described herein may be repeated or performed in parallel with one another or in parallel with different instances of the same or other similar acts.

FIG. 8 illustrates an example series of acts 800 for generating, storing, retrieving, and providing feature families for machine learning features. The series of acts 800 can include an act 802 of receiving an indication of a plurality of machine learning features to group. In particular, the act 802 can involve receiving, from a first client device, an indication of a plurality of machine learning features to group within a feature family repository of an inter-network facilitation system.

As shown, the series of acts 800 also includes an act 804 of generating a feature family for the plurality of machine learning features. In particular, the act 804 can involve, in response to the indication of the plurality of machine learning features, generate a feature family to store within the feature family repository and comprising feature references indicating respective network locations where the plurality of machine learning features are stored. For example, the act 804 can involve generating the feature family to include offline machine learning features stored at network locations updated on a periodic basis and online machine learning features stored at network locations updated concurrently with network activity within the inter-network facilitation system.

Additionally, the series of acts 800 includes an act 806 of receiving a request for the feature family. In particular, the act 806 can involve receiving a request to implement the feature family with a machine learning model. For example, the act 806 involves receiving a request to verify an action associated with a second client device, the action comprising a login, a funds transfer, an account registration, a credit request, a transaction dispute, or an online payment. In some cases, the series of acts 800 includes an act of determining an entity name associated with the request that indicates an entity corresponding to the feature family within the inter-network facilitation system. Additionally, the series of acts 800 can include an act of determining that the request indicates the feature family by comparing a stored entity name associated with the feature family within the feature family repository and a requested entity name indicated within the request. In one or more embodiments, the act 806 involves receiving the request to implement the feature family for one or more of training the machine learning model or applying the machine learning model for generating a prediction.

As further illustrated in FIG. 8, the series of acts 800 includes an act 808 of retrieving the plurality of machine learning features to provide for the request. In particular, the act 808 can involve, in response to the request, retrieve the plurality of machine learning features from the respective network locations indicated by the feature references of the feature family to provide the plurality of machine learning features to the machine learning model. For example, the act 808 can involve providing the plurality of machine learning features to the machine learning model without generating a new feature family corresponding to the request.

In some embodiments, the series of acts 800 includes an act of updating feature values corresponding to each of the plurality of machine learning features within the feature family by requesting updated feature value data from the respective network locations on a periodic basis. In these or other embodiments, the series of acts 800 includes an act of receiving an additional request to implement a different feature family not stored within the feature family repository. Further, the series of acts 800 can include an act of, in response to the additional request, generating an additional feature family corresponding to the additional request to store within the feature family.

The series of acts 800 can also (or alternatively) include an act of updating feature values associated with the plurality of machine learning features associated with the feature family based on detecting a trigger event associated with the plurality of machine learning features from network activity within the inter-network facilitation system. Additionally, the series of acts 800 can include acts of identifying a machine learning feature associated with the feature family that is not required to perform an action associated with the request to implement the feature family and, in response to identifying the machine learning feature that is not required, providing a modified subset of machine learning feature within the feature family to the machine learning model that does not include the machine learning feature that is not required.

Further, the series of acts 800 can involve generating, based on the plurality of machine learning features associated with the feature family indicated by the request and based on the machine learning model, predicted weights for the plurality of machine learning features for implementation via the machine learning model. In some cases, the series of acts 800 includes an act of receiving a prediction query requesting feature information regarding the feature family used to generate a prediction via the machine learning model at a particular point in time. In addition, the series of acts 800 includes an act of determining, in response to receiving the prediction query, feature values for the plurality of machine learning features associated with the feature family at the particular point in time.

In one or more embodiments, the series of acts 800 includes an act of determining feature names for machine learning features indicated within a plurality of requests for the feature family, wherein each of the plurality of requests indicate less than all stored feature names associated with the feature family. In addition, the series of acts 800 includes an act of identifying, based on comparing the feature names indicated within the plurality of requests with the stored feature names, a machine learning feature that is named in less than a threshold percent of the plurality of requests for the feature family. Further, the series of acts 800 includes an act of generating an additional feature family to exclude a feature reference indicating a network location where the machine learning feature that is named in less than a threshold percent of the plurality of requests is stored.

In certain cases, the series of acts 800 includes an act of receiving an additional request to implement a different feature family not stored within the feature family repository. Additionally, the series of acts 800 includes an act of determining similarity scores for a plurality of feature families stored within the feature family repository in relation to the different feature family indicated by the additional request. The series of acts 800 can also include an act of providing, in response to the additional request, one or more machine learning features indicated by a particular feature family with a highest similarity score in relation to the different feature family. In some embodiments, the series of acts 800 includes an act of determining the similarity scores by comparing machine learning features associated with the different feature family with machine learning features associated with each of the plurality of feature families stored within the feature family repository. The series of acts 800 can also include an act of receiving an additional request to implement the feature family utilizing a different machine learning model and an act of, in response to the additional request, retrieving the plurality of machine learning features from the respective network locations to provide the plurality of machine learning features to the different machine learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 (e.g., the client devices 108a-108n, or the server(s) 106) that may be configured to perform one or more of the processes described above. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output interface 908 (or “I/O interface 908”), which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that connects components of computing device 900 to each other.

FIG. 10 illustrates an example network environment 1000 of the inter-network facilitation system 104. The network environment 1000 includes a client device 1006 (e.g., client devices 108a-108n), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation systems 104, third-party systems 1008, and networks 1004, this disclosure contemplates any suitable number of client devices 1006, inter-network facilitation system 104, third-party systems 1008, and networks 1004. As an example, and not by way of limitation, network environment 1000 may include multiple client devices 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, the inter-network facilitation system 104 (which hosts the feature family system 102), and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party system 1008. For example, the inter-network facilitation system 104 may receive authentication credentials from a user to link a third-party system 1008 such as an online banking system to link an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) between user accounts or across accounts of different third-party systems 1008, and to present corresponding information via the client device 1006.

In particular embodiments, the inter-network facilitation system 104 includes a model (e.g., a machine learning model) for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles and/or account information for credit accounts, secured accounts, secondary accounts, and other affiliated financial networking system accounts. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A system comprising:
at least one processor; and
a non-transitory computer readable medium comprising instructions that, when executed by the at least one processor, cause the system to:
receive, from a first client device, an indication of a plurality of machine learning features to group within a feature family repository of an inter-network facilitation system;
in response to the indication of the plurality of machine learning features, generate a feature family to store within the feature family repository and comprising feature references indicating respective network locations where the plurality of machine learning features are stored;
receive a request to implement the feature family with a machine learning model; and
in response to the request, retrieve the plurality of machine learning features from the respective network locations indicated by the feature references of the feature family to provide the plurality of machine learning features to the machine learning model.

2. The system of claim 1, further comprising instructions that, when executed by the at least one processor, cause the system to receive the request to implement the feature family by receiving a request to verify an action associated with a second client device, the action comprising a login, a funds transfer, an account registration, a credit request, a transaction dispute, or an online payment.

3. The system of claim 1, further comprising instructions that, when executed by the at least one processor, cause the system to determine that the request indicates the feature family by comparing a stored entity name associated with the feature family within the feature family repository and a requested entity name indicated within the request.

4. The system of claim 1, further comprising instructions that, when executed by the at least one processor, cause the system to update feature values corresponding to each of the plurality of machine learning features within the feature family by requesting updated feature value data from the respective network locations on a periodic basis.

5. The system of claim 1, further comprising instructions that, when executed by the at least one processor, cause the system to provide the plurality of machine learning features to the machine learning model without generating a new feature family corresponding to the request.

6. The system of claim 1, further comprising instructions that, when executed by the at least one processor, cause the system to generate the feature family to include offline machine learning features stored at network locations updated on a periodic basis and online machine learning features stored at network locations updated concurrently with network activity within the inter-network facilitation system.

7. The system of claim 1, further comprising instructions that, when executed by the at least one processor, cause the system to receive the request to implement the feature family for one or more of training the machine learning model or applying the machine learning model for generating a prediction.

8. A method comprising:
receiving, from a first client device, an indication of a plurality of machine learning features to group within a feature family repository of an inter-network facilitation system;
in response to the indication of the plurality of machine learning features, generating a feature family to store within the feature family repository and comprising feature references indicating respective network locations where the plurality of machine learning features are stored;
receiving a request to implement the feature family with a machine learning model; and
in response to the request, retrieving the plurality of machine learning features from the respective network locations indicated by the feature references of the feature family to provide the plurality of machine learning features to the machine learning model.

9. The method of claim 8, further comprising:
receiving an additional request to implement a different feature family not stored within the feature family repository; and
in response to the additional request, generating an additional feature family corresponding to the additional request to store within the feature family.

10. The method of claim 8, further comprising updating feature values associated with the plurality of machine learning features associated with the feature family based on detecting a trigger event associated with the plurality of machine learning features from network activity within the inter-network facilitation system.

11. The method of claim 8, further comprising:
identifying a machine learning feature associated with the feature family that is not required to perform an action associated with the request to implement the feature family; and
in response to identifying the machine learning feature that is not required, providing a modified subset of machine learning feature within the feature family to the machine learning model that does not include the machine learning feature that is not required.

12. The method of claim 8, further comprising generating, based on the plurality of machine learning features associated with the feature family indicated by the request and based on the machine learning model, predicted weights for the plurality of machine learning features for implementation via the machine learning model.

13. The method of claim 8, further comprising:
receiving a prediction query requesting feature information regarding the feature family used to generate a prediction via the machine learning model at a particular point in time; and
determining, in response to receiving the prediction query, feature values for the plurality of machine learning features associated with the feature family at the particular point in time.

14. The method of claim 8, further comprising:
determining feature names for machine learning features indicated within a plurality of requests for the feature family, wherein each of the plurality of requests indicate less than all stored feature names associated with the feature family;
identifying, based on comparing the feature names indicated within the plurality of requests with the stored feature names, a machine learning feature that is named in less than a threshold percent of the plurality of requests for the feature family; and
generating an additional feature family to exclude a feature reference indicating a network location where the machine learning feature that is named in less than a threshold percent of the plurality of requests is stored.

15. A non-transitory computer readable medium comprising instructions that, when executed by at least one processor, cause a computing device to:
receive, from a first client device, an indication of a plurality of machine learning features to group within a feature family repository of an inter-network facilitation system;
in response to the indication of the plurality of machine learning features, generate a feature family to store within the feature family repository and comprising feature references indicating respective network locations where the plurality of machine learning features are stored;
receive a request to implement the feature family with a machine learning model; and
in response to the request, retrieve the plurality of machine learning features from the respective network locations indicated by the feature references of the feature family to provide the plurality of machine learning features to the machine learning model.

16. The non-transitory computer readable medium of claim 15, further comprising instructions that, when executed by the at least one processor, cause the computing device to determine an entity name associated with the request that indicates an entity corresponding to the feature family within the inter-network facilitation system.

17. The non-transitory computer readable medium of claim 15, further comprising instructions that, when executed by the at least one processor, cause the computing device to:
receive an additional request to implement a different feature family not stored within the feature family repository; and
determine similarity scores for a plurality of feature families stored within the feature family repository in relation to the different feature family indicated by the additional request.

18. The non-transitory computer readable medium of claim 17, further comprising instructions that, when executed by the at least one processor, cause the computing device to provide, in response to the additional request, one or more machine learning features indicated by a particular feature family with a highest similarity score in relation to the different feature family.

19. The non-transitory computer readable medium of claim 17, further comprising instructions that, when executed by the at least one processor, cause the computing device to determine the similarity scores by comparing machine learning features associated with the different feature family with machine learning features associated with each of the plurality of feature families stored within the feature family repository.

20. The non-transitory computer readable medium of claim 15, further comprising instructions that, when executed by the at least one processor, cause the computing device to:
receive an additional request to implement the feature family utilizing a different machine learning model; and
in response to the additional request, retrieve the plurality of machine learning features from the respective network locations to provide the plurality of machine learning features to the different machine learning model.
